(19) United States
(12) Patent Application Publication
(10) Pub. No.: US 2002/0196999 A1
(43) Pub. Date: Dec. 26, 2002

(54) Gimbaled optical switch

(75) Inventors: Gerald H. Kim, Edmonds, WA (US); Spencer G. Nelson, Bothell, WA (US); Joe D. Ridge, Sammamish, WA (US); Steven M. Swedenburg, Bothell, WA (US); Nikolaos D. Xydas, Bothell, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Bainbridge Networks, Inc.

(21) Appl. No.: 09/938,865

(22) Filed: Aug. 24, 2001

Related U.S. Application Data
(60) Provisional application No. 60/300,505, filed on Jun. 22, 2001.

(51) Int. Cl. G02B 6/35

(52) U.S. Cl. 385/16; 385/22

(57) ABSTRACT

An optical switch includes a number of input modules each of which have an optical fiber, one or more lenses bonded to the fiber, and a gimbaling mechanism that selectively aligns the optical module. In one embodiment of the invention, each of the modules and associated gimbaling mechanisms is individually replaceable in the optical switch. In one embodiment of the invention, the optical modules are fitted in spheres that are positioned by motors that move push rods to engage an annular flange surrounding the sphere. In other embodiment, motors rotate the spheres directly to gimbal the optical modules.

### CROSS-REFERENCE TO RELATED APPLICATION

The present application is related to U.S. Provisional Application No. 60/300,505, filed Jun. 22, 2001, and claims the benefit of the filing date thereof under 35 U.S.C. § 119(e).

### FIELD OF THE INVENTION

The present invention relates to switches for transmitting light between optical fibers.

### BACKGROUND OF THE INVENTION

As optical fibers replace conventional copper wires for transporting high volumes of communication and other signals, there is a need for high speed switches that can effectively route these signals. In the past, such switches have most commonly been electrically based. That is, the optical signals transmitted on the fibers are converted to an electrical form and routed through an electronic switch before being reconverted back to an optical form for delivery into another optical fiber. Such switches are generally complex and inefficient because the form of the signals must be changed from an optical to an electrical form and back at each switching point.

In a fully optical switch, a light beam is mechanically deflected from one fiber to another. Mechanisms for deflecting the beam typically include opto-mechanical devices, MEMS (microelectrical mechanical systems) mirrors, liquid crystal materials, electro-optically active polymeric materials and electroholographic materials. While fully optical switches have the advantage of not requiring a transformation of a signal into a different form in order to be routed through the switch, conventional deflection-based optical switches often have high signal losses and require expensive packaging or costly labor-intensive alignment. In addition, such switches may have high crosstalk, non-uniform attenuation of a signal across the switch, slow switching speeds or bulky form factors.

### SUMMARY OF THE INVENTION

An optical switch according to the present invention includes at least one input module having a gimbaling mechanism that can align the input module with one of a number of output modules.

In one embodiment of the invention, each input and output module and gimbaling mechanism can be individually adjusted or replaced in the switch without affecting the remaining input or output modules. This modularity allows for upgrading (increasing the size of) the switch by adding additional input and output ports without interfering with the operation of the switch. Additionally, the modularity allows for servicing the switch (replacing faulty modules) without interfering with the operation of the switch.

In one embodiment of the invention, the gimbaling mechanism comprises a sphere in which an input port is received. An output port may also be received into a sphere to achieve a similar gimbaling mechanism. The spheres can be selectively pivoted or rotated to align the input module with an output module. If the switch is bi-directional, it can operate such that the ‘output’ ports can be the transmitting side and the ‘input’ ports can be the receiving side of the switch.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an environment where optical switches, including those of the present invention, are used;

FIG. 2 illustrates an N×N optical switch in accordance with one embodiment of the present invention;

FIG. 3 illustrates an N×N optical switch having interchangeable modules in accordance with another aspect of the present invention;

FIG. 4 illustrates a pair of frames having an arrangement of opposing optical ports according to yet another aspect of the present invention;

FIGS. 5A-5B illustrate an optical module used in the optical switch of the present invention; and

FIGS. 6 and 7 are exploded views of one embodiment of a gimbaling mechanism for moving an optical module in accordance with another aspect of the present invention.

### DETAILED DESCRIPTION OF THE PREFERRED EMBODIMENT

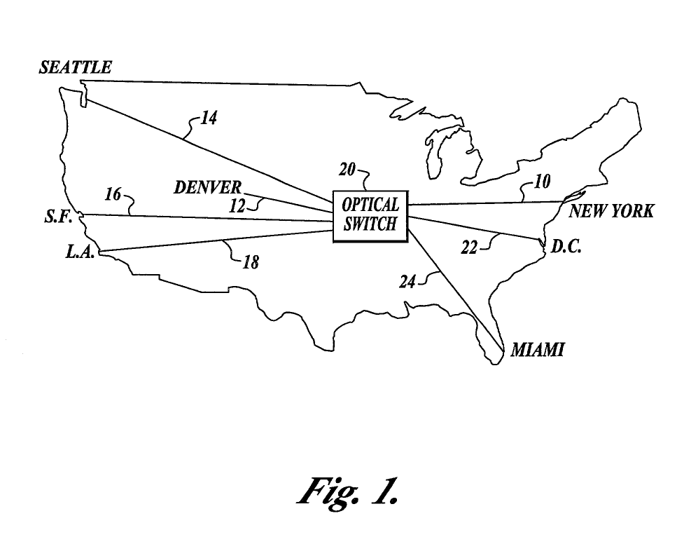

In any communication system, signals need to be routed from one location to another. In a large-scale communication system such as a nationwide telephone network, telephone or other communication signals are often routed on an input optical fiber or leg to an optical switch, where the signals are transferred to other legs that connect the signals to the intended destinations. As shown in FIG. 1, an optical switch 20 directs telephone communication signals on an incoming leg to any one of a number of output legs 12, 14, 16, 18, 22, 24, etc., that carries signals to different parts of the country. For example, telephone signals to be routed from New York to Los Angeles may be transmitted on a first leg 10 to the optical switch 20, where the signals are directed to a leg 18 that extends to Los Angeles. This example depicts a domestic networking application, however, the present invention can be extended to a global scale.

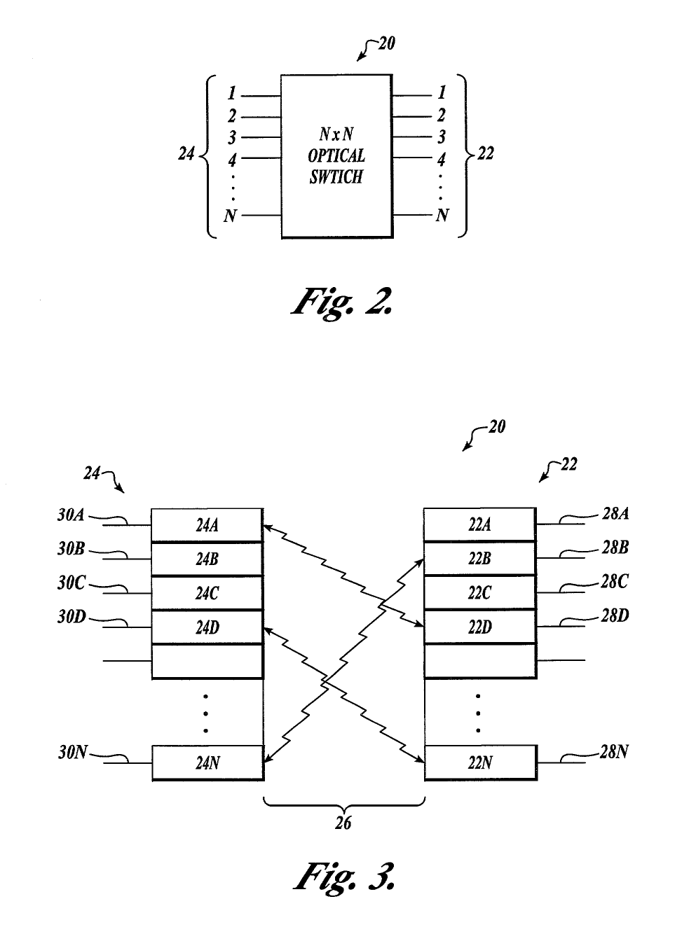

FIG. 2 illustrates an N×N optical switch. The switch 20 includes a set of N input modules 22 and a set N of output modules 24. Light from any one of the N input modules 22 may be switched to any of the N output modules 24. The optical switch 20 may be bidirectional such that the input and output modules may be reversed and light on any of the N output modules 24 be switched to any of the N input modules 22.

Although the optical switch 20 is preferably configured as an N x N switch having equal numbers of input and output modules, the switch 20 may be configured as an N×M switch where the number of input and output modules are not the same.

FIG. 3 illustrates the N input modules 22A-22N and the N output modules 24A-24N that are separated by a space 26 in an optical switch 20. Each of the input modules 22A-22N has a corresponding optical fiber 28A-28N and a beam gimbaling mechanism (not separately shown) that orients an input module toward one of the output modules. Similarly, the output modules 24A-24N each have an optical fiber 30A-30N and a beam gimbaling mechanism (not shown) that can be activated to orient the output module to receive light from any of the input modules or to transmit light to any of the input modules.

If the optical switch is a one-way switch such that light from any input module can be directed to any of the output modules but not vice versa, the output modules may remain fixed and not have a beam gimbaling mechanism.

Although light generally passes from one input module to a single output module, it is also possible that light from two or more input modules may be directed to the same output module, thereby causing the optical switch 20 to operate as a multiplexer. The input light may be comprised of many wavelengths or of a single wavelength. When multiplexing light from two or more input modules onto a single output module, the output fiber can be populated with multiple wavelengths, comprised of those wavelengths being transmitted by each of the input modules. Wavelength inclusion or deletion can be addressed by the addition of wavelength selective components prior to the light entering the switch or between the input and output modules of the switch. Examples of these wavelength selective components are, but are not limited to, arrayed waveguide gratings, fiber Bragg gratings, fixed wavelength filters, and tunable wavelength filters. Also, the optical switch may be used in conjunction with dense wavelength division multiplexing (DWDM) equipment.

In the optical switch 20, according to one embodiment of the present invention, any of the input or output modules 22, 24 and corresponding beam gimbaling mechanism is formed as a modular unit and therefore may be replaced or realigned without affecting the operation of any of the remaining modules. This allows the optical switch to be easily maintained or upgraded without disturbing any of the other input or output modules. The switch is inherently scalable, meaning that the switch can be upgraded just by populating additional ports with input/output modules.

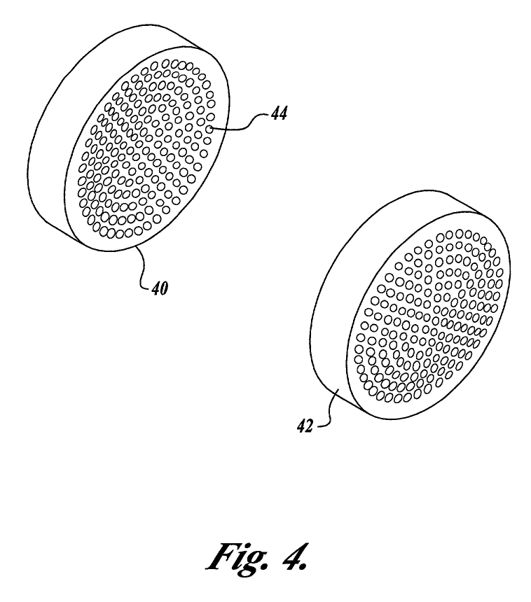

FIG. 4 illustrates one possible embodiment of a housing that aligns the input modules with the output modules of the optical switch 20 of the type shown in FIG. 3. The housing includes a pair of opposed forms 40, 42 that hold the number of input modules 22 and output modules 24, respectively. The form 40 has a number of ports 44 into which the modules having a beam gimbaling mechanism are fitted. The pattern of ports 44 in the form may take a variety of configurations, including a rectangular grid or, as shown in FIG. 4, a number of concentric circles. In the embodiment shown, the opposing faces of the forms 40, 42 are concave in shape such that the angular distance required to direct light from an input module to an output module is minimized. Another advantage of the concave surface of the forms 40, 42 is that the rearward surface of the form can be made to be convex in shape, such that the ends of the beam gimbaling mechanisms are spaced further apart than they are at the concave surface of the forms. This allows for easier insertion, removal, or alignment of the beam gimbaling mechanisms within the form. Furthermore, the increased space provides room for the controlling electronics of the gimbaling mechanisms.

Although forms 40, 42 having concave opposing surfaces are currently preferred, it would be appreciated that the present invention can also be used with forms that are planar or have other shapes, depending upon the number of ports in the switch and other requirements.

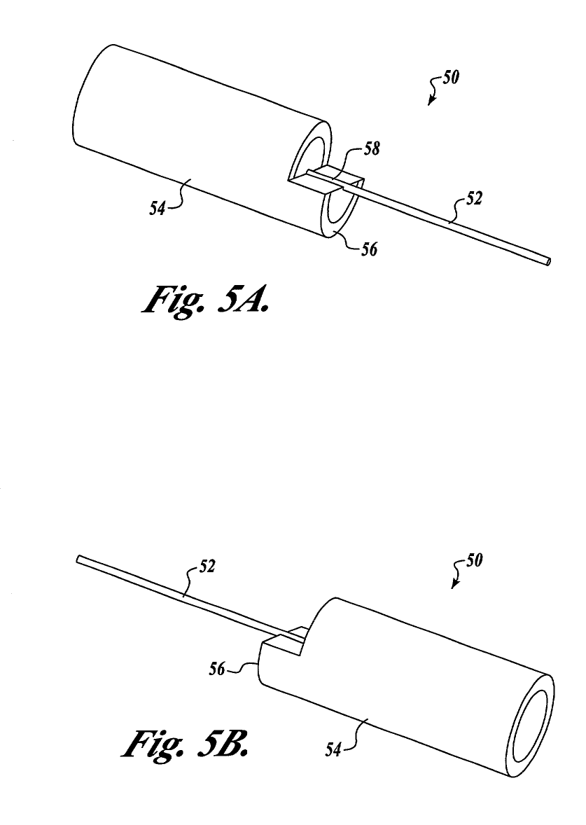

FIGS. 5A and 5B illustrate one mechanism of how an optical fiber and lens assembly are secured together to form an optical module that is moved by a beam gimbaling mechanism. An optical module 50 includes an optical fiber 52 that is secured to a lens assembly 54. The lens assembly 54 has a step 56 on one end and a notch 58, in the step 56. The notch 58 maintains the position of the optical fiber 52 with respect to one or more lenses in the lens assembly 54 such that the fiber is aligned at or near the optical axis and focal point of the lens assembly in order to ensure that light exiting the lens assembly is collimated and that the Rayleigh's distance of the light is maximized. The Rayleigh's distance is the distance the light travels while maintaining collimation. It is generally preferable to maximize this distance as this gives an expanded region in which the optical train of the switch has optimal operation characteristics (efficient coupling of the light between input and output modules). In addition, this on-axis configuration minimizes aberrations as the light traverses the system. In one embodiment of the invention, the lens assembly 54 has a single GRIN lens; however, other lenses could be used, depending on the desired optical characteristics such as the distance between the ports, the number of ports, Rayleigh's distance, etc.

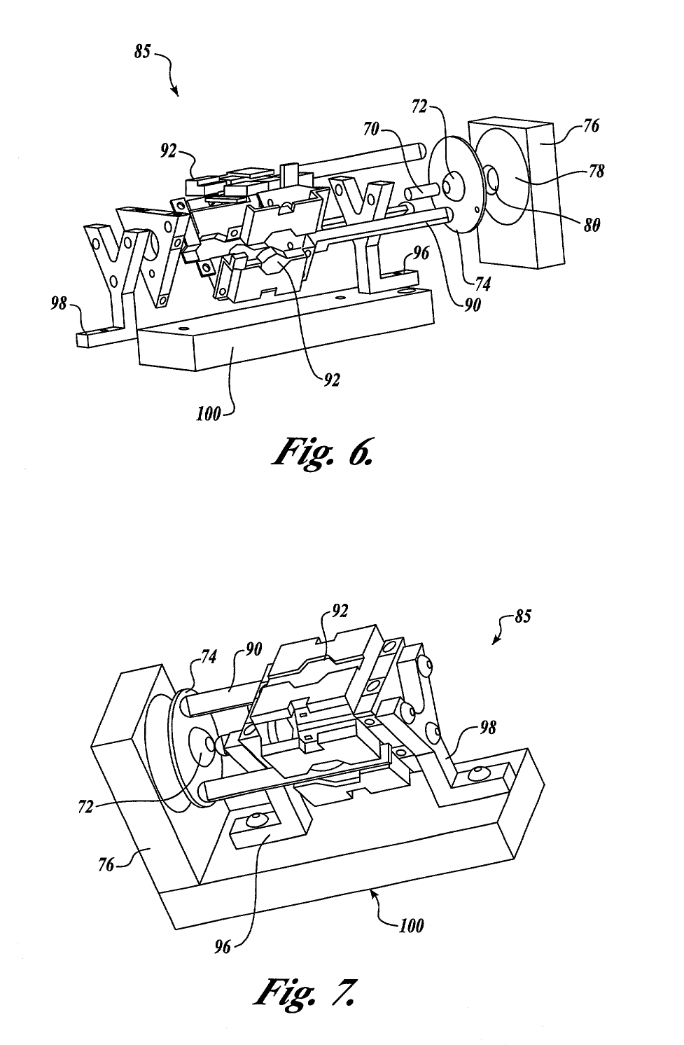

FIGS. 6 and 7 illustrate one embodiment of a gimbaling mechanism 85 for moving the optical modules in the optical switch of the present invention. An optical module 70, having an optical fiber (not shown) and lens assembly is fitted in a gimbaling mechanism that includes a frame such as moveable sphere 72 that allows the module to be rotated in three dimensions within a support. The sphere 72 has a hole through its center into which the optical module 70 is fitted. Surrounding the sphere 72 is an annular flange 74 that extends out from the center of the sphere to allow the sphere to be moved by actuators that engage the annular flange.

To support the sphere 72, it is seated in a faceplate 76 having a raised conical section 78. The conical section 78 has a hole 80 that is smaller than the diameter of the sphere 72 such that the sphere rests on the perimeter of the hole 80 and can be rotated or reoriented within the conical section 78 by pushing the annular flange 74.

In the currently preferred embodiment of the invention, there are three push rods 90 that are positioned at equal intervals around the circumference of the annular flange 74. Each push rod 90 comprises a composite beam that is moved by a composite motor 92. The motors are supported by a pair of brackets 96, 98 that are mounted to a base 100 to which the faceplate 76 is also secured. Upon application of the driving signal to the composite motors 92, a force is created on the push rods 90 that cause the push rods 90 to press in varying degrees against the annular flange 74. Movement of the flange 74 causes the orientation of the sphere 72 within the conical section 78 of the faceplate 76 to be changed, thereby changing the orientation of the optical module 70 in the optical switch.

In one embodiment of the invention, the optical switch 20 comprises a number of lens gimbaling mechanisms 85 of the type shown in FIGS. 6 and 7 that are placed in the opposing forms 40, 42 such as those shown in FIG. 4. In order to direct light from one port to another, appropriate driving signals are applied to the composite motors 92 in order to align an input module with an output module.

In order to monitor the position of the optical module 70, the gimbaling mechanism preferably includes one or more position sensors that can be read to determine the position of each of the push rods 90. For example, the push rods may be optically encoded and a sensor positioned to read the encoding on each push rod in order to determine the orientation of the optical module 70. Alternatively, the push rods may be encoded with an electrical position sensing system such as a resistance-based or capacitance-based sensor that allows the position of the push rods to be determined. Furthermore, the sphere 72 that holds the optical module may be encoded with an optical or electrical code that is read by a sensor to determine the orientation of the optical module 70.

As an alternative to the gimbaling mechanism 85 shown in FIGS. 6 and 7, the composite motors may be positioned directly against a composite sphere that is suspended by a number of bearings. The ceramic motors then rotate the composite sphere directly by the application of appropriate driving signals in order to reorient the optical module.

Other embodiments of a gimbaling mechanism for directing the optical modules are also contemplated. These embodiments include: a piezoelectric stack, piezo benders, piezolinear motors, polymeric materials, many coil linear actuators, electrostatic MEMS, electromagnetic voice coils, electro-optic deflectors, stepper motors with lead screws, DC motors with lead screws, galvo mirrors, and acousto-optic deflectors or other systems that gimbal the optical module in order to change the orientation of a sphere or other frame in which the module is placed.

To further monitor the coupling of light between an input module and an output module, it may be desirable to have a feedback loop that monitors the interrogated light. Light is tapped off a fiber that impinges upon a detection system. The information of beam intensity and/or shape is used as a feedback mechanism for a server control that positions the components of the optical switch in one or both of the input or output modules. The feedback provides information on fine tuning the alignment between the modules. Alternatively, a number of light sensors may surround the target optical module. Signals from each of these sensors can be used to further adjust the position of the gimbaling mechanism in order to maximize the light coupling between the input and output modules.

While the preferred embodiment of the invention has been illustrated and described, it will be appreciated that various changes can be made therein without departing from the scope of the invention. It is therefore intended that the scope of the invention be determined from the following claims and equivalents thereto.

The embodiments of the invention in which an exclusive property or privilege is claimed are defined as follows:

1. An optical switch for transmitting light from at least one input module to one of a number of output modules comprising:
at least one input module including an optical fiber bonded to one or more lenses;
a number of output modules each of which includes an optical fiber bonded to one or more lenses;
a gimbaling mechanism associated with each input module that orients the input modules toward one of the number of output modules.

2. The optical switch of claim 1, wherein the gimbaling mechanism includes:
a sphere in which the one or more lenses of the input module are positioned; and
an actuator for changing the orientation of the sphere.

3. The optical switch of claim 2, wherein the sphere has a flange and the actuator comprises:
a number of push rods that engage the flange; and
a number of motors that drive the push rods to change the orientation of the sphere.

4. The optical switch of claim 3, wherein the push rods are made of a ceramic material and the motors move the push rods toward or away from the flange.

5. The optical switch of claim 3, wherein the push rods are encoded to detect the position of the sphere and therefore the orientation of the input module.

6. The optical switch of claim 2, wherein the actuator includes a ceramic motor that moves the sphere directly.

7. The optical switch of claim 1, wherein the optical fibers of the input and output modules are bonded at or near the optical axis and focal point of the one or more lenses.

8. An optical switch, comprising:
at least one input module having an optical fiber and one or more lenses coupled to the optical filter;
a number of output modules each of which includes an optical fiber and one or more lenses coupled to the optical fiber;
a gimbaling mechanism associated with each input module that orients the input module toward an output module, the gimbaling mechanism including:
(a) a sphere into which the input module is fitted; and
(b) means for rotating the sphere toward one of the number of output modules.

9. The optical switch of claim 8, wherein the sphere is encoded and the gimbaling mechanism includes a sensor for reading the encoding to determine the orientation of the input module.

10. A switch for transmitting light from at least one input optical module to one of a number of output optical modules, comprising:
a first and second form into which a number of optical modules are positioned, wherein at least the input optical modules each have a beam directing mechanism that orients the input optical modules toward an output optical module;
wherein the input modules and beam directing mechanisms can be individually replaced in the forms.

11. The switch of claim 10, wherein the forms have concave surfaces that face each other.

12. The switch of claim 11, wherein the form in which the input modules are positioned has a convex rear surface that spreads the distance between adjacent beam directing mechanisms.

13. A communication switch comprising:
a number of input optical fibers each of which is bonded to a lens assembly including one or more lenses to form an input module;
a number of output optical fibers each of which is bonded to a lens assembly including one or more lenses to form an output module;
a number of gimbaling mechanisms to selectively orient the input modules toward an output module.

14. The communication switch of claim 13, wherein the input and output optical fibers are bonded to the lens assemblies at or near the optical axis and focal point of the lens assemblies.

15. The communication switch of claim 13, wherein each lens assembly includes a GRIN lens.

16. A gimbaling mechanism for selectively orienting an optical fiber in an optical switch, comprising;
a support;
a frame movably positioned within the support;
one or more actuators that move the frame within the support;
wherein the frame receives an optical fiber and lens assembly and is moved by the one or more actuators in order to direct light from the optical fiber.

17. A gimbaling mechanism for selectively orienting an optical fiber in an optical switch, comprising:
a sphere in which an optical fiber and lens assembly are fitted;
a support in which the sphere is fitted;
means for moving the sphere in the support in order to direct light from the optical fiber.

18. An optical switch for directing light on an input fiber to one of a number of output fibers, comprising:
at least one input fiber bonded to a lens assembly;
a number of output fibers bonded to lens assemblies;
a gimbaling mechanism for selectively orienting the input fiber toward one of the number of output fibers;
a form that separates the at least one input fiber and the number of output fibers.

19. The optical switch of claim 18, wherein the opposing faces of the form are concave in shape.

20. The optical switch of claim 18, wherein the non-opposing faces of the form are convex in shape.

21. The optical switch of claim 18, wherein the opposing faces of the forms are planar.

22. The optical switch of claim 18, further comprising
a feedback mechanism associated with each of the number of output fibers for adjusting the operation of the gimbaling mechanism.

23. The optical switch of claim 22, wherein the feedback mechanism includes a tap on the output optical fibers to sample the light received by the output optical fiber.

24. The optical switch of claim 22, wherein the feedback mechanism includes one or more light sensors positioned near the output optical fibers for generating signals proportional to the amount of light falling on the one or more sensors.

25. An optical multiplexer, comprising:
two or more input optical modules each having an optical fiber and one or more lenses coupled to the optical fiber;
a number of output optical modules each having an optical fiber and one or more lenses coupled to the optical fiber;
a gimbaling mechanism associated with at least the two or more input optical modules for orienting the two or more input optical modules toward the same output optical module.

26. The optical multiplexer of claim 25, wherein the gimbaling mechanism includes a sphere in which the input modules are located and a mechanism for selectively orienting the sphere.

27. The optical multiplexer of claim 26, wherein the mechanism for selectively orienting the sphere includes an annular flange surrounding the sphere and a number of push rods that engage the annular flange.

28. The optical multiplexer of claim 26, wherein the sphere is made of a composite material and the mechanism for selectively orienting the sphere comprises a number of composite motors positioned adjacent the sphere to move the sphere directly.
